(19) United States
(12) Patent Application Publication
(10) Pub. No.: US 2014/0330995 A1
(43) Pub. Date: Nov. 6, 2014

(54) DATA STORAGE SYSTEM

(71) Applicants: Paul S. Levy, Chandler, AZ (US); William N. Gallas, Queen Creek, AZ (US); John Huie, Anthem, AZ (US)

(72) Inventors: Paul S. Levy, Chandler, AZ (US); William N. Gallas, Queen Creek, AZ (US); John Huie, Anthem, AZ (US)

(21) Appl. No.: 14/268,283

(22) Filed: May 2, 2014

Related U.S. Application Data
(60) Provisional application No. 61/819,269, filed on May 3, 2013.

(51) Int. Cl. G06F 13/16; G06F 13/42

(52) U.S. Cl. CPC G06F 13/1694; G06F 13/4282
USPC 710/105

(57) ABSTRACT

In an embodiment, a storage device may include a tangible non-transitory physical storage for storing information. The storage device may also include an interface. The interface may be used to receive a signal that may be associated with one of a plurality of different protocols. The signal may be received serially. The storage device may include circuitry which may be used to identify a protocol associated with the received signal. The protocol may be identified based on an attribute associated with the received signal. Alternatively or in addition to, the protocol may be identified based on information encoded in the received signal. The information encoded in the received signal may include, for example, a data header that may be associated with the protocol.

### RELATED APPLICATIONS

This application claims priority to and the benefit of U.S. Provisional Application No. 61/819,269 titled “Data Storage System” and filed on May 3, 2013, the contents of which are incorporated by reference as though fully set forth herein.

### BACKGROUND

A computing device may use one or more storage devices to store information. The information may include, for example, data and/or executable instructions. The storage devices may include, for example, hard disk drives (HDDs). A hard disk drive may store information on a disk. The disk may be divided into sectors and information may be stored in the sectors. The information may be read by accessing a sector containing the information.

A storage device may include an interface that may be used to interface the storage device with, for example, a processor contained in a computing device. The interface may utilize a protocol for transferring information between the storage device and the processor. Examples of protocols that may be used include the serial advanced technology attachment (SATA) protocol, parallel advanced technology attachment (PATA) protocol, small computer system interface (SCSI) protocol, peripheral component interconnect (PCI) protocol, PCI express (PCIe) protocol, and the serial attached SCSI protocol (SAS) protocol.

The protocols may contain provisions for transferring signals between the storage device and processor. The signals may be transferred between the storage device and the processor via a cable. The signals may include, for example, data and/or control signals.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 illustrates a block diagram of an example embodiment of a storage device;

FIG. 2 illustrates a block diagram of an example embodiment of a protocol detector that may be contained in a storage device;

FIG. 3 illustrates a block diagram of an example embodiment of a clock control and 8B/10B data execution unit that may be contained in a storage device;

FIG. 4 illustrates a block diagram of an example embodiment of drive logic that may be contained in a storage device;

FIG. 5 illustrates a block diagram of an example embodiment of logic that may be contained in a storage device;

FIG. 6 illustrates a block diagram of an example embodiment of self-booting logic that may be contained in a storage device;

FIG. 7 illustrates a block diagram of an example embodiment of a network-based compute services system that include one or more storage devices; and

FIGS. 8 and 9 illustrate block diagrams of example embodiments of port adapters that may be used with storage devices.

### DETAILED DESCRIPTION

The following detailed description refers to the accompanying drawings. The same reference numbers in different drawings may identify the same or similar elements. Also, the following detailed description does not limit the invention.

A storage device may be used to store information. The information may include data and/or computer-executable instructions. The information may be made randomly and/or serially accessible by the storage device. Examples of storage devices include, but are not limited to, hard disk drives (HDDs), solid-state drives (SSDs), and hybrid drives. A hybrid drive may include a combination of HDD technology and SSD technology to store information.

A storage device may include an interface that may be used to interface the storage device with, for example, a processor contained in a computing device. Typically, the interface may support transferring information (e.g., data, computer-executable instructions) between the storage device and the processor using a single protocol such as, for example, serial advanced technology attachment (SATA) protocol, parallel advanced technology attachment (PATA) protocol, small computer system interface (SCSI) protocol, peripheral component interconnect (PCI) protocol, PCI express (PCIe) protocol, and the serial attached SCSI (SAS) protocol. This may limit the versatility of the storage device as the storage device may be limited to transferring information using a single protocol.

For example, suppose a storage device supports transferring information using only the SATA protocol. A computing device that communicates with storage devices using a different protocol (e.g., PCIe) may not be able to communicate with the storage device. Thus, in this situation, the versatility of the storage device may be considered limited.

Techniques described below may be used to enhance a versatility of a storage device by enabling the storage device to communicate using multiple protocols. One or more storage devices described below may include, for example, a tangible non-transitory physical storage for storing information. The information may include data and/or computer-executable instructions. The storage devices may include one or more processors. At least one of the processors may be, for example, a general purpose processor. The storage devices may include an interface for receiving signals that may correspond to different protocols. The interface may be a serial interface. The storage devices may include circuitry that may determine a one of the different protocols based on a signal received by the interface.

For example, as will be described further below, a storage device may include a protocol detector that may contain a clock control unit and a plurality of execution units. The clock control unit may be used to identify a protocol based on certain criteria (e.g., clock frequency). The execution units may be used to process information transferred between the storage device and an external device that may be external to the storage device. The information may be transferred serially between the storage device and the external device.

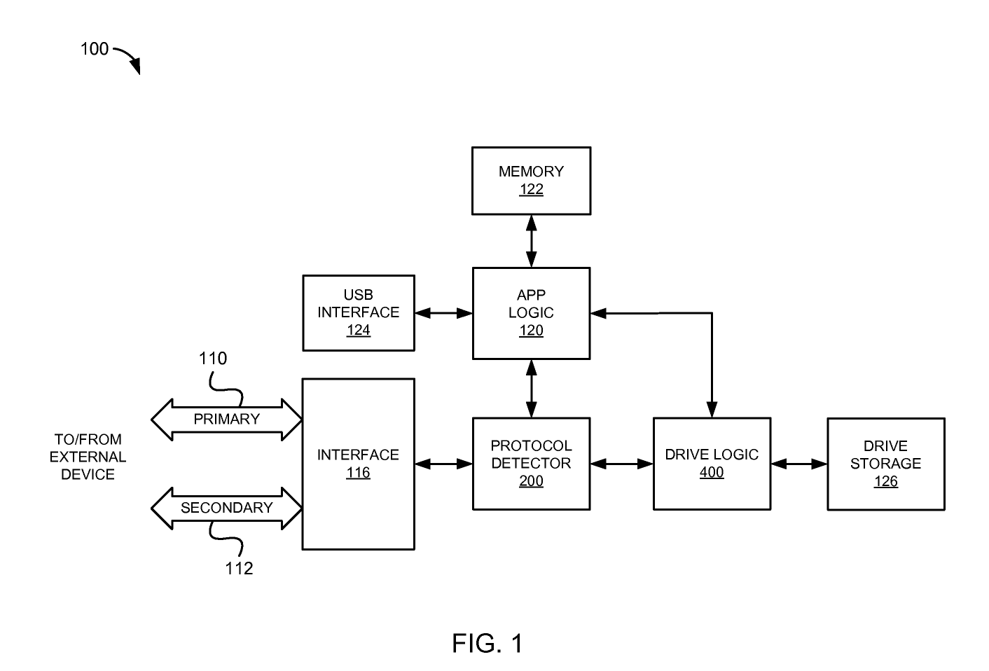

FIG. 1 illustrates a block diagram of an example embodiment of a storage device 100. Referring to FIG. 1, storage device 100 may include a primary connection 110, a secondary connection 112, an interface 116, a protocol detector 200, application processing logic (APP logic) 120, a universal serial bus (USB) interface 124, a memory 122, drive logic 400, and drive storage 126.

The primary connection 110 and secondary connection 112 may connect the storage device 100 to an external device (e.g., a processor, network switch) that may communicate with storage device 100. Connections 110 and 112 may include, for example, cables that may connect signals between a connector on the external device and interface 116. The signals may include, for example, control signals and/or data signals.

The signals may be encoded at a hardware level as low voltage differential signals (LVDS). Connections 110 and 112 in aggregate may, for example, provide redundant connections between the storage device 100 and the external device. The redundant connections may be used to support, for example, failover and/or port aggregation.

Protocol detector 200 may process signals that may be transferred to/from the storage device 100 via connections 110 and/or 112 and interface 116. The processing may include, for example, identifying a protocol that may be associated with the signals and routing the signals to an execution unit based on the identified protocol. Details regarding the execution units and protocol detector 200 will be described further below.

Application processing logic 120 may include logic that may implement, for example, a processor. An example of a processor that may be implemented by processing logic 120 may be an Intel® Architecture (IA) processor. The application processing logic 120 may be programmed to handle various protocol stack implementations to provide storage access. For example, application processing logic 120 may be programed to implement an Internet Protocol (IP) protocol stack that may be used to service IP based storage protocols.

It should be noted that application processing logic 120 may be general purpose and may not be limited to supporting storage protocols. For example, application processing logic 120 may, for example, execute an operating system (OS) and/or application programs. Examples of OSs that may be executed by processing logic 120 include Linux and Microsoft® Windows®.

An application program that may be executed by application processing logic 120 may include an application program that may operate on information stored in the drive storage 126. For example, instead of merely responding to data read and write requests as a slave device, the application program may provide a wide variety of data services. For example, the application program may service queries that may identify multiple data entries, perform background operations (e.g., to copy and/or convert information from one format to another), implement backup of information to other devices, among other potential applications.

Further, an application program executed by application processing logic 120 may, for example, automate various tasks such as converting a network attached storage (NAS) presented folder of moving picture experts group (MPEG) formatted video to a second H.264 folder. Other application programs executed by application processing logic 120 may write information from the storage device 100 to other storage devices (e.g., in a redundant array of independent disks (RAID) scheme), detect and respond to platter or sector failure, perform compression of information stored by the storage device 100, control power consumption of the storage device 100, among other possible applications.

In addition, the application processing logic 120 need not operate on stored information at all, but may instead be used as a general computing resource that may execute user defined programs. Typically, storage devices exhibit bursty behavior—e.g., a series of reads/writes followed by idle periods. During these idle periods, applications may be executed by the application processing logic 120. In environments pooling many storage devices, these general computing elements may aggregate into a substantial computing resource and potentially offer some significant power savings.

Application processing logic 120 may be communicatively coupled to memory 122. Memory 122 may include volatile memory and/or non-volatile memory. A volatile memory may be a memory that may lose information stored in that memory when power to the memory is removed. A non-volatile memory may be a memory that may retain information stored in the memory when power is removed from the memory.

Memory 122 may include circuitry that may implement an error correction code (ECC) for correcting errors associated with information stored in memory 122. Memory 122 may include circuitry that may implement an error detection scheme that may be used to detect errors associated with information stored in memory 122. These error detection and correction schemes may include, for example, parity, cyclic-redundancy checks (CRCs), and/or checksums.

Memory 122 may store program instructions that may be executed by application processing logic 120. The program instructions may include, for example, program instructions that may be provisioned by a manufacturer or dynamically downloaded.

The application processing logic 120 may also have access to a variety of offload engines that may speed common operations such as Transmission Control Protocol (TCP) offload, User Datagram Protocol (UDP), security offload (e.g., Advanced Encryption Standard (AES), Secure Sockets Layer/Internet Protocol Security (SSL/IPSec), and/or data storage protocol offload (e.g., T10 for SCSI).

The application processing logic 120 may interface with a USB interface 124. The USB interface 124 may be used to communicate with, for example, an external device (e.g., computing device). The USB interface 124 may be used to facilitate USB storage protocols. An example of a USB storage protocol that may be facilitated is the USB Attached SCSI (UAS) storage protocol.

Drive logic 400 may include logic that may implement service SAS and/or SATA data requests. The drive logic 400 may also include logic that may handle accessing (e.g., reading, writing) information that may be contained in the drive storage 126. Drive logic 400 may include logic that may control head positioning, provide platter drive motor control, perform logical block address (LBA) to track mapping, and so forth.

Drive logic 400 may include one or more execution units that may be programmable. The execution units may utilize a variety of storage-related protocols. Examples of protocols that may be utilized by the execution units include, but are not limited to, IP, PCIe, SATA, and/or SAS. Examples of execution units that may be included in drive logic 400 will be described further below.

The drive storage 126 may provide tangible non-transitory physical storage for the storage device 100. The storage may be provided, for example, by one or more platters that may magnetically store information. Here the platters may be attached to a spindle that may be turned by a spindle motor. Information may be read from the platters using one or more read/write heads. The read/write heads may be positioned using an actuator motor.

Alternatively or in addition to, storage associated with drive storage 126 may be provided by one or more memory devices. The memory devices may include, for example, volatile and/or non-volatile memory devices.

A volatile memory device may be a memory device that may lose information stored in the device when power is removed from the device. A non-volatile memory device may be a memory device that may retain information stored in the device when power is removed from the device. Examples of memory devices that may be included in drive storage 126 include, but are not limited to, random access memory (RAM) devices, dynamic RAM (DRAM) devices, flash memory devices, static RAM (SRAM) devices, zero-capacitor RAM (ZRAM) devices, twin transistor RAM (TTRAM) devices, read-only memory (ROM) devices, electrically alterable read only memory (EAROM) devices, ferroelectric transistor RAM (FeTRAM) devices, magneto-resistive RAM (MRAM) devices, nanowire-based devices, resistive RAM devices (RRAM), serial electrically erasable programmable ROM (SEEPROM) devices, and/or serial flash devices.

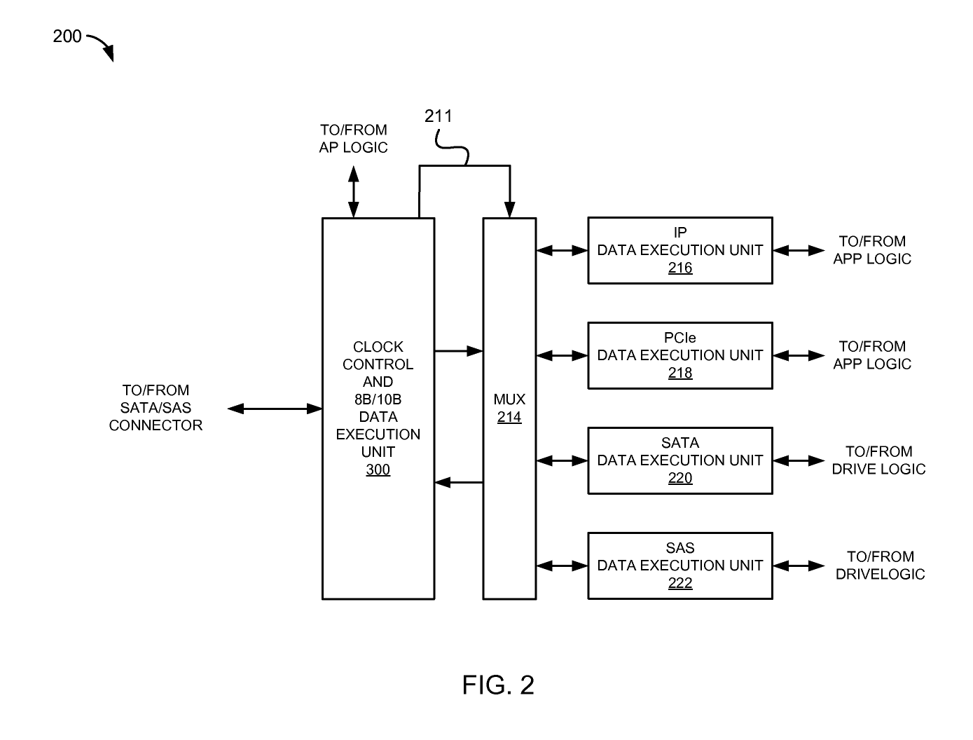

FIG. 2 illustrates a block diagram of an example embodiment of protocol detector 200. Referring to FIG. 2, protocol detector 200 may include a clock control and 8B/10B data execution unit 300, a multiplexor (MUX) 214, an IP data execution unit 216, a PCIe data execution unit 218, a SATA data execution unit 220, and a SAS data execution unit 222.

The clock control and 8B/10B data execution unit 300 may include circuitry that may be used to identify a protocol being associated with a signal that is transferred to storage device 100. The signal may be transferred to storage device 100 via a SATA cable. The cable may be connected to SATA/SAS connector that may be included in interface 116. The protocol may be identified by the data execution unit 300 based on a signaling characteristic of the signal. Note that signal may be associated with one of a plurality of protocols that may be used to communicate with storage device 100. Clock control and 8B/10B data execution unit 300 may receive the signal, disambiguate the protocol being used, and respond appropriately.

After identifying the protocol, data execution unit 300 may generate a select signal 211 that may be fed to MUX 214. The select signal 211 may be used to route the signal via MUX 214 to a data execution unit which may further process the protocol associated with the signal. Examples of data execution units that may be contained in protocol detector 200 include IP data execution unit 216, PCIe data execution unit 218, SATA data execution unit 220, and SAS data execution unit 222, which may be used to process the IP protocol, PCIe protocol, SATA protocol and SAS protocol, respectively, that may be associated with the signal.

For example, suppose data execution unit 300 identifies a protocol associated with a signal being used to communicate with the storage device 100 as the SATA protocol. Data execution unit 300 may generate a select signal 211 that configures MUX 214 to route the signal to SATA data execution unit 220.

Data execution units 216, 218, 220, and 222 may process signals associated with the IP, PCIe, SATA, and SAS protocols, respectively. Processing may include, for example, performing protocol related operations that may be defined by the protocols. The protocol related operations may be performed by the data execution units 216, 218, 220, and 220 or in combination with other logic contained in storage device 100 such as, for example, APP logic 120 or drive logic 400.

For example, the SAS data execution unit 220 and SATA data execution unit 222 may interact with drive logic 400 to service data access requests associated with the SAS and SATA protocols, respectively.

In another example, the IP data execution unit 216 may, for example, perform some, or all, protocol stack operations that may be associated with the IP protocol. Alternately, for example, TCP/IP or UDP/IP operations may be distributed among the IP data execution unit 216 and APP logic 120. For example, the IP data execution unit 216 may verify datagram checksums, perform defragmentation, and so forth while the APP logic 120 may update connection context and handle connection setup and teardown. Note that a wide variety of other distributions of these operations may be implemented.

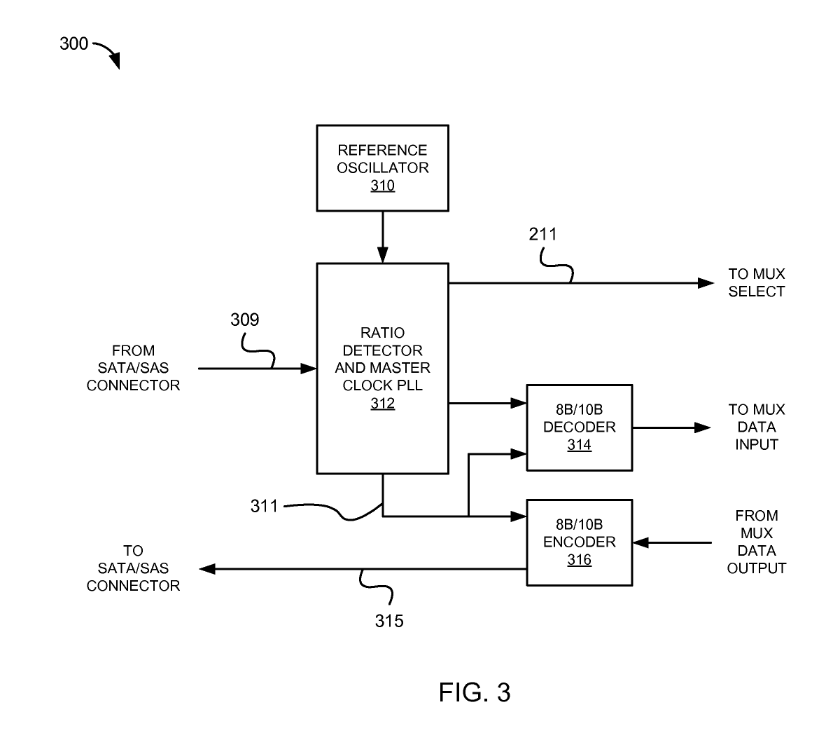

FIG. 3 illustrates a block diagram of an example embodiment of a clock control and 8B/10B data execution unit 300. Referring to FIG. 3, clock control and 8B/10B data execution unit 300 may include a reference oscillator 310, ratio detector and master clock phase-locked loop (PLL) circuitry 312, an 8B/10B decoder 314, and a 8B/10B encoder 316.

The reference oscillator 310 may provide a reference signal for the ratio detector and master clock PLL circuitry 312. The reference signal may be used, for example, to measure a frequency associated with a signal 309 that may be input into ratio detector and master clock PLL 312 from interface 116.

Signal 309 may be a signal that may be used to communicate with storage device 100. The signal 309 may be encoded using an 8B/10B encoding scheme although other encoding schemes may be used. Signal 309 may be associated with a protocol such as, for example, the SAS, SATA, PCIe, or IP protocol.

Signal 309 may be associated with various attributes. The various attributes may be unique across multiple protocols. One or more attributes associated with signal 309 may be used, for example, by ratio detector and master clock PLL 312 circuitry to identify a protocol associated with signal 309.

For example, an example of an attribute that may be associated with signal 309 is a frequency of signal 309. The frequency of signal 309 may be used by ratio detector and master clock PLL circuitry 312 to identify a protocol associated with signal 309.

Table 1 below lists various protocols and their characteristic frequencies:

TABLE 1

| Protocol | Frequency in Gigahertz (GHz) |
|---|---|
| Gigabit Ethernet (Gbe) Serial | 0.625 |
| Gigabit Media Independent | |
| Interface (SGMII) | |
| SAS/SATA 1 | 0.750 |
| SATA 2 | 1.5 |
| PCI Express 1.1 | 1.25 |
| SATA 3 | 3.0 |

To identify a protocol associated with signal 309, ratio detector and master clock PLL circuitry 312 may detect a ratio of the frequency of signal 309 to the frequency of master clock PLL circuitry 312. This ratio may be used to identify a protocol associated with signal 309. A value of select signal 211 may be identified based on, for example, the identified protocol and/or ratio.

For example, suppose signal 309 is associated with the SATA 3 protocol. Further, suppose reference oscillator 310 generates a reference frequency of 1 GHz. Ratio detector and master clock PLL circuitry 312 may compare the reference frequency with the frequency of signal 309 and determine that the frequency of signal 309 is three times greater than the reference frequency. Thus, the ratio identified by ratio detector and master clock PLL circuitry 312 may be 3 to 1 or simply 3. Based on the identified ratio, ratio detector and master clock PLL circuitry 312 may determine that signal 309 is associated with the SATA 3 protocol and identify a value for signal 211 based, for example, on this determination.

It should be noted that frequency is an example of an attribute of signal 309 that ratio detector and master clock PLL 312 may use to identify a protocol associated with signal 309. Ratio detector and master clock PLL 312 may use other attributes of signal 309 and/or other criteria to identify a protocol associated with signal 309. The other criteria may include, for example, information encoded in signal 309.

For example, signal 309 may contain header data that may be associated with a data packet. Ratio detector and master clock PLL 312 may examine the header data and use the results of examining the header data alone or in combination with the identified ratio to identify the protocol associated with signal 309.

Ratio detector and master clock PLL 312 may include a PLL. The PLL may generate a master clock signal 311 based on the determined frequency of signal 309. The master clock signal 311 may be distributed to 8B/10B decoder 314 and 8B/10B encoder 316 which may decode data from signal 309 and encode data on signal 315, respectively, based on the master clock signal 311. Data decoded from signal 309 may be transferred to MUX 214 (FIG. 2) for routing to a particular data execution unit 216, 218, 220, and 222.

Data from MUX 214 may be encoded on signal 309. Specifically, 8B/10B encoder 316 may which may receive data from MUX 214. The data may be received by MUX 214 from a particular data execution unit 216, 218, 220, and 222. Using the master clock signal 311, 8B/10B encoder 316 may encode the received data onto signal 315. Signal 315 may be transferred external to the storage device 100 via interface 116.

The protocol associated with signal 309 may be dynamically determined by clock control and 8B/10B data execution unit 300. The enabled protocol may be “sticky”—that is, protocol circuitry and/or a data path used to process signal 309 may be determined for initially received signals and left unchanged unless, for example, an event occurs. Examples of events may include an accumulation of data errors accumulate that may indicate a change in received signaling, a periodic timer expires, or some other event. Additionally, while storage device 100 may be shown as a dynamically adaptive system, an operator may manually and/or remotely configure the storage device 100 to a given protocol.

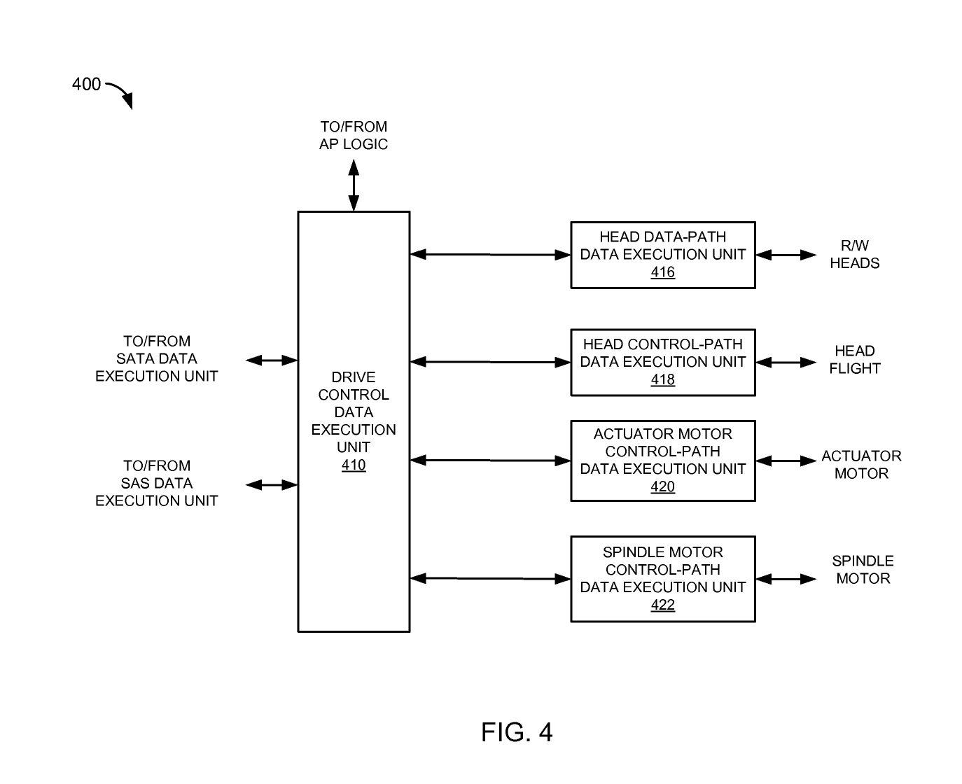

FIG. 4 illustrates a block diagram of an example embodiment of drive logic 400. Referring to FIG. 4, drive logic 400 may include a drive control data execution unit 410, a head data-path data execution unit 416, a head control-path data execution unit 418, an actuator motor control-path data execution unit 420, and a spindle motor control-path data execution unit 422.

Head control-path data execution unit 418, actuator motor control-path data execution unit 420, and spindle motor control-path data execution unit 422 may be used to control read/write heads, an actuator motor, and a spindle motor that may be associated with storage device 100. For example, SATA data execution unit 220 (FIG. 2) or SAS data execution unit 222 may generate various signals that may be associated with storing/retrieving data contained in drive storage 126. These signals may be transferred to drive control and data execution unit 410 which may use these signals to direct an operation of head data-path data execution unit 416, head control-path data execution unit 418, actuator motor control-path data execution unit 420, and spindle motor control-path data execution unit 422 to store the data in drive storage 126.

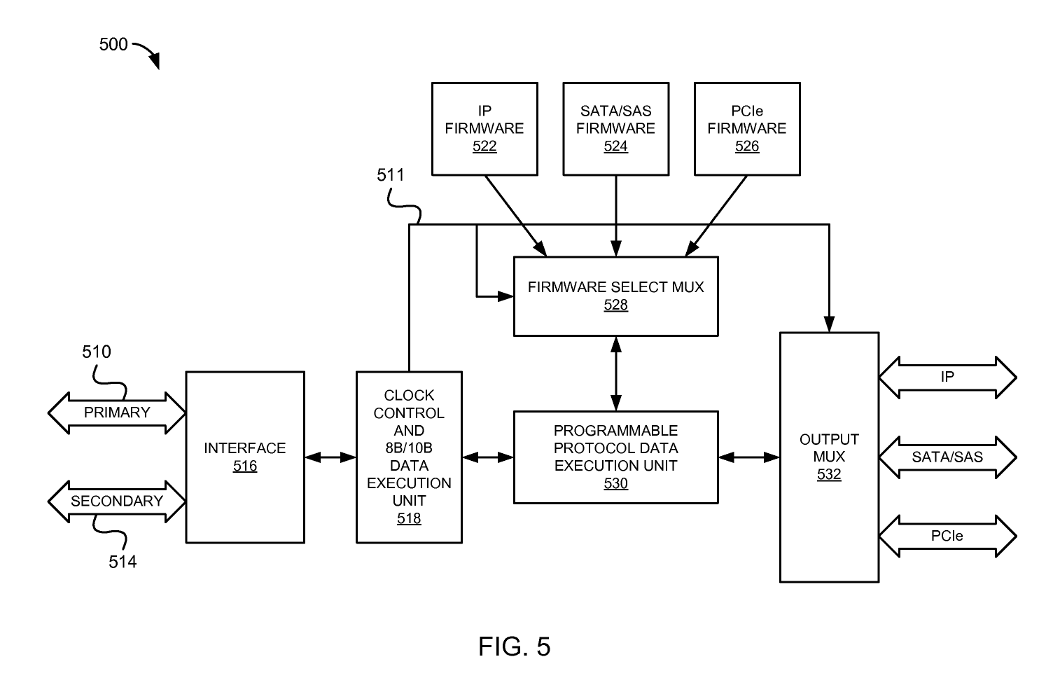

FIG. 5 illustrates a block diagram of an example embodiment of logic 500 that may be contained in a storage device. Logic 500 may include a primary connection 510, a secondary connection 514, an interface 516, a clock control and 8B/10B data execution unit 518, IP firmware instructions 522, SATA/SAS firmware instructions 524, PCIe firmware instructions 526, a firmware select multiplexor (MUX) 528, a programmable protocol data execution unit 530, and an output multiplexor (MUX) 532.

The primary connection 510 and secondary connection 514 may connect the storage device to an external device (e.g., a processor, network switch) that may communicate with storage device 100. Connections 510 and 514 may include, for example, cables that may connect signals between a connector on the external device and a connector that may be included in interface 516. The signals may include, for example, control signals and/or data signals.

The signals may be encoded at a hardware level as low voltage differential signals (LVDS). Connections 510 and 514 in aggregate may provide redundant connections between the external device and the storage device. The redundant connections may be used to support, for example, failover and/or port aggregation.

The storage device may store or receive firmware instructions 522, 524, 526 for different protocols. The firmware instructions 522, 524, 526 may program programmable protocol data execution unit 530 which may be a general purpose processor, field programmable gate array

(FPGA), or other programmable circuitry. The firmware instructions 522, 524, 526 may be loaded in response to an output of clock control and 8B/10B data execution unit 518. Alternately, the firmware instructions 522, 524, 526 may be downloaded and/or selected by remote administration.

The clock control and 8B/10B data execution unit 518 may include logic that may determine which protocol is being used to communicate with the storage device and respond appropriately. The data execution unit 518 may identify an incoming protocol based on an attribute associated with a signal received by the storage device via connections 510 and/or 514. The protocol may be identified based on the attribute such as, for example, described above.

After identifying the protocol, data execution unit 518 may generate a select signal 511 that may be fed to firmware select MUX 528. The select signal 511 may be generated based on the identified protocol. The select signal 511 may be used to configure MUX 528 to select firmware that may be used to program programmable protocol data execution unit 530.

After being programmed, programmable protocol data execution unit 530 may process data from clock control and 8B/10B data execution unit 518. The processed data may be transferred to output MUX 532 which may output the processed data as control and/or data signals associated with the IP, SATA, SAS, and/or PCIe protocols.

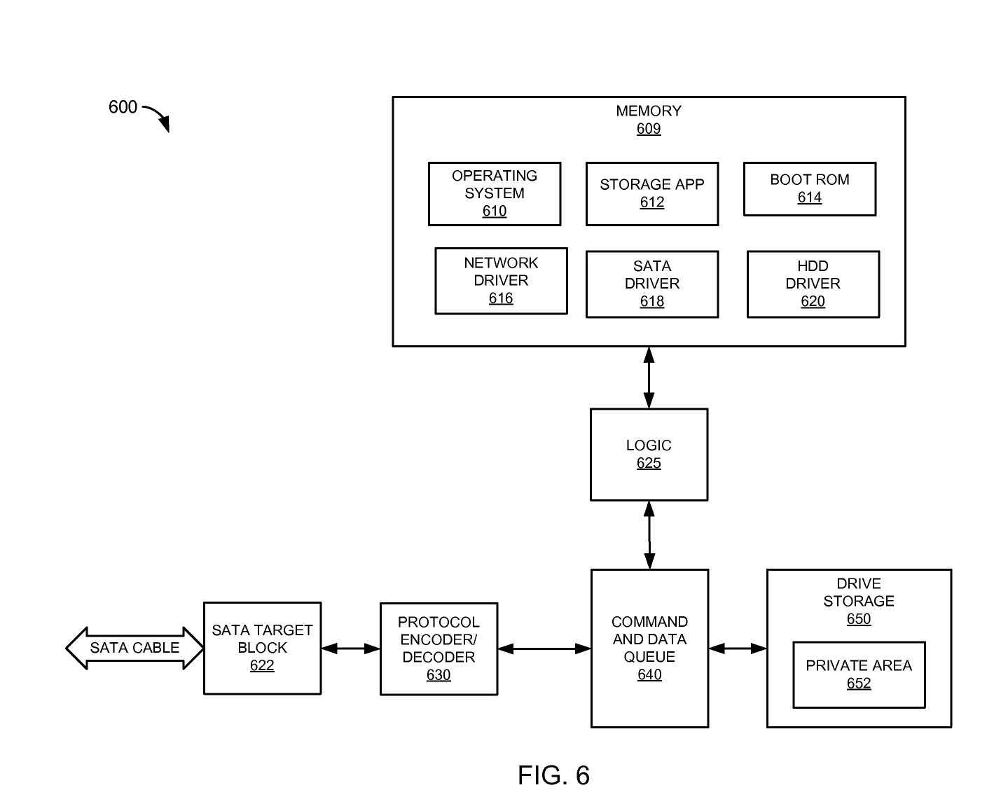

FIG. 6 illustrates a block diagram of an example embodiment of self-booting logic that may be contained in storage device 600. Referring to FIG. 6, storage device 600 may include a memory 609, logic 625, SATA target block 622, protocol encoder/decoder 630, command and data queue 640, and drive storage 650.

The SATA target block 622 may interface the storage device 600 with a SATA cable. The protocol encoder/decoder 630 may encode/decode SATA data and/or signals. The command and data queue 640 may implement queues for commands and data associated with the storage device 600.

The drive storage 650 may be a tangible non-transitory physical storage that may store information. The information may include, for example, data and/or computer-executable instructions. The storage may be provided, for example, by one or more platters that may magnetically store information such as described above. Alternatively or in addition to, the storage may be provided by one or more memory devices. The memory devices may include, for example, volatile and/or non-volatile memory devices such as, for example, described above.

Memory 609 may include an operating system 610, a storage application (APP) 612, a boot read-only memory (ROM) 614, a network driver 616, a SATA driver 618, and an HDD driver 620. The drive storage 660 may contain a private area 652. Instructions that implement the operating system 610, a storage APP 612, network driver 616, SATA driver 618, and/or HDD driver 620 may be may be stored in the private area 652. The private area 652 may be an established storage in the drive storage 650 that may be cordoned off from external access. For example, the private area 652 may be an area in the drive storage 650 that is not exposed externally to the storage device by an LBA.

During a boot operation and/or initialization of storage device 600, logic 625 may include circuitry (e.g., a processor) to execute instructions contained in boot ROM 614. The instructions when executed may direct command and data queue 640 to read operating system 610, storage application (APP) 612, boot read-only ROM 614, network driver 616, SATA driver 618, and/or HDD driver 620 into memory 609 for execution by logic 625.

Returning back to FIG. 1, storage device 100 may be included in a wide variety of architectures. For example, storage device 100 may be attached to a host featuring one or more processors coupled to the storage device 100. For example, a laptop, server blade, or cellular mobile device having a display and touchscreen may feature such a storage device 100.

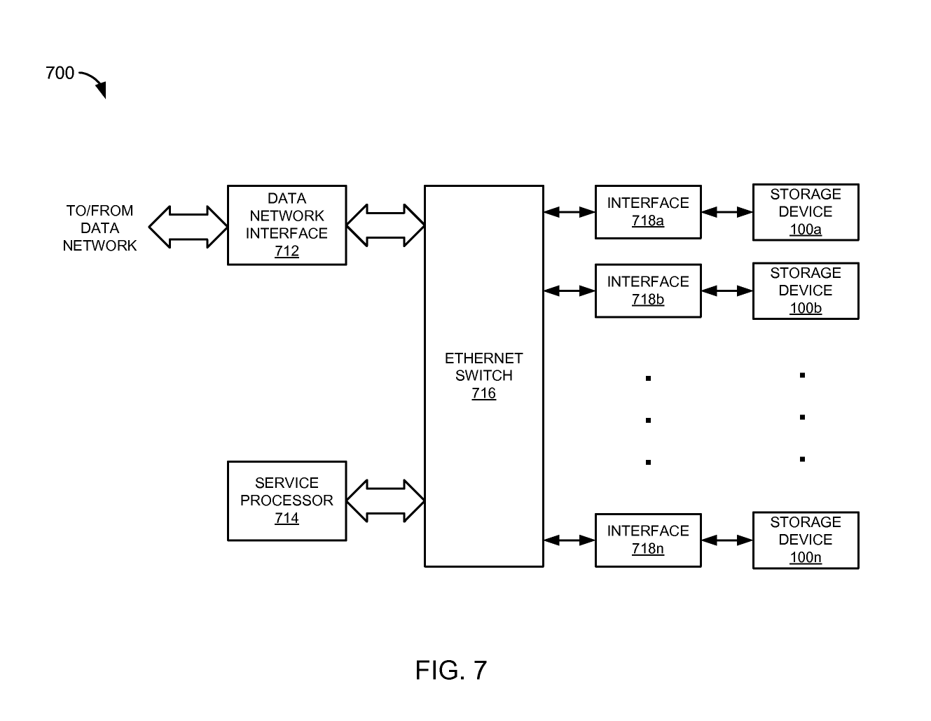

FIG. 7 illustrates a block diagram of an example embodiment of a networked compute services system 700 that includes one or more storage devices 100a-n. As shown in FIG. 7, storage devices 100a-n may be aggregated by an Ethernet switch 716. Here, each storage device 100 may feature at least one unique Ethernet address. The Ethernet switch 716 may forward Ethernet frames to the storage devices 100a-n. Such an architecture may pool a tremendous amount of data storage capacity and compute power, for example, in a server rack having one or more server blades. A server blade may be used to aggregate the multiple storage devices 100a-n for inclusion in a server rack.

The service processor 714 may be used to, inter alia, configure the Ethernet switch 716 and/or one or more of the storage devices 100a-n. The data network interface 712 may provide an interface between the Ethernet switch 716 and a data network.

Interfaces 718a-n may interface storage devices 100a-n, respectively, to the Ethernet switch 716. In an embodiment, an interface 718 includes a SATA cable that carries serial gigabit media independent interface (SGMII) signaling between the Ethernet switch 716 and a storage device 100.

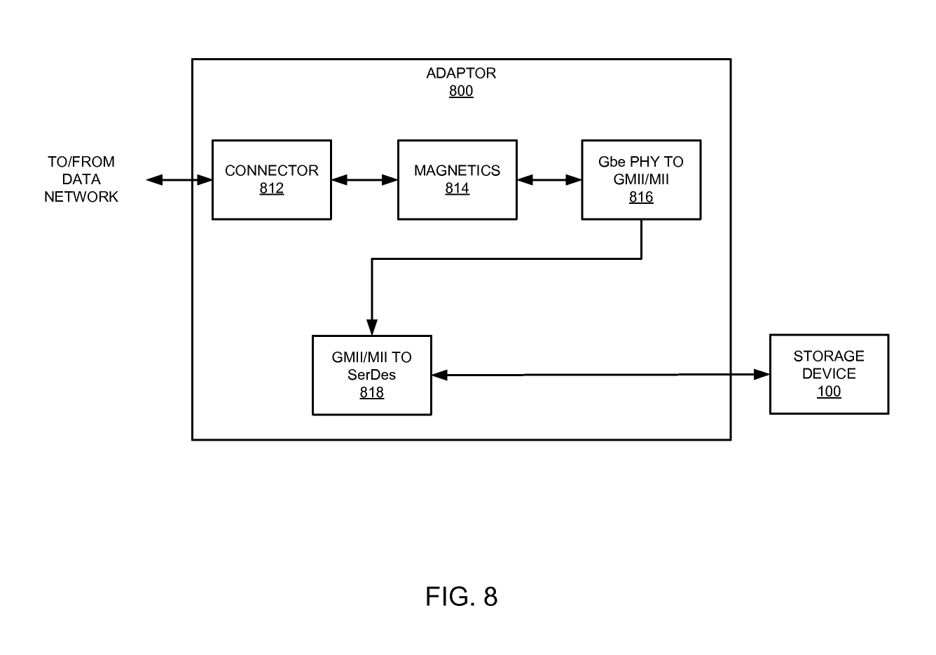

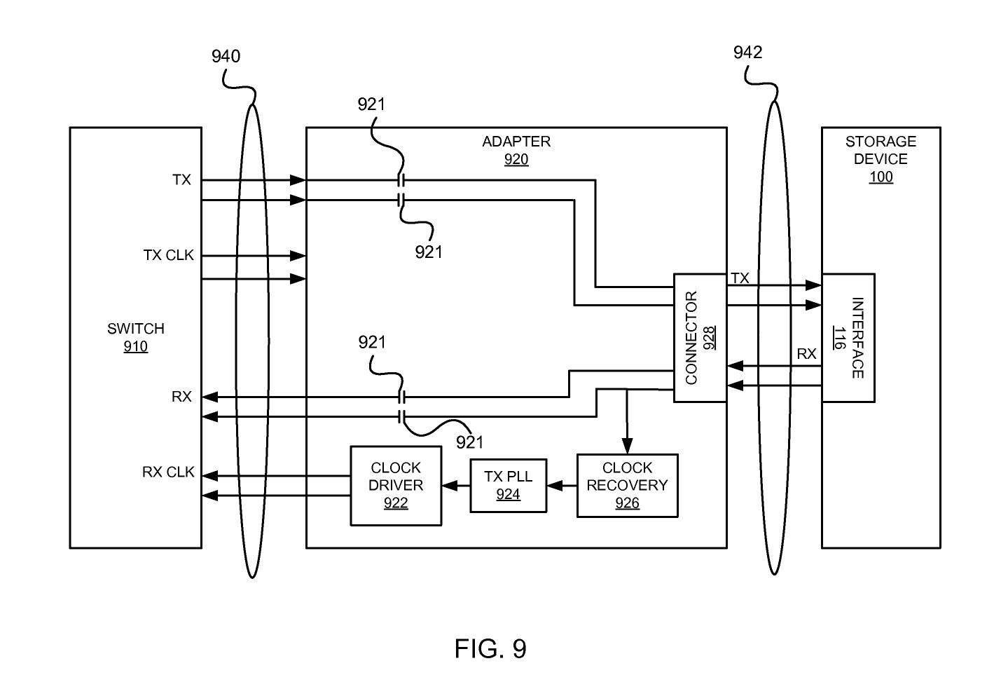

Storage device 100 may feature a single type of port, such as a SAS/SATA serial connector. For other physical interfaces, a port adapter may be used to convert one physical signaling stream to another. FIGS. 8 and 9 illustrate examples of port adapters that may be used.

The port adapter 800 shown in FIG. 8 may include a connector 812, magnetics 814, Gbe physical layer (PHY) to gigabit media independent interface/media independent interface (GMII/MII) circuitry 816, and GMII/MII to serial/deserializer (SerDes) circuitry 818. The port adapter 800 may adapt a Gbe signal to a serial output.

The adapter may pair Gbe PHY to GMII/MII circuitry 816 with GMII/MII to SerDes circuitry 818 thereby, for example, adapting a Gbe PHY signal to a serial signal. The Gbe PHY to GMII/MII circuitry 816 may handle equalization and cable training. Such an adapter 800 may be independent or integrated into storage device 100.

In an embodiment, connector 812 may include an RJ45 connector that may interface with a data network via a Gbe Ethernet cable. The GMII/MII to SerDes circuitry 818 may include a SATA connector that may interface with the storage device via a SATA cable.

FIG. 9 depicts a different implementation of a port adaptor 920 that converts a gigabit Ethernet signal to a serial signal. Referring to FIG. 9, port adapter 920 may include a connector 928, a clock driver 922, a transmit (TX) PLL, clock recovery circuitry 926, and coupling capacitors 921.

Switch 910 may be a gigabit Ethernet switch that may interface with the adapter 920 via an SGMII interface 940. TX and receive (RX) signals from switch 910 may be transferred through the adapter 920 to connector 928. The TX and RX signals may be conveyed to interface 116 on storage device 100 via a SATA cable 942. In this example, connector 928 may be a SATA connector to which one end of SATA cable 942 may be connected and interface 116 may include a SATA connector to which the other end of SATA cable 942 may be connected.

RX data transferred from storage device 100 to adapter 920 may include a clock. Clock recovery circuitry 926 may recover the clock and feed the recovered clock to TX PLL 924. TX PLL 924 may include phase-locked loop circuitry that may be used to stabilize the recovered clock. The TX PLL 924 may output the stabilized recovered clock to clock driver 922 which may drive the stabilized recovered clock onto SGMII interface 940.

The foregoing description of embodiments is intended to provide illustration and description, but is not intended to be exhaustive or to limit the invention to the precise form disclosed. Modifications and variations are possible in light of the above teachings or may be acquired from practice of the invention.

Also, the term “user”, as used herein, is intended to be broadly interpreted to include, for example, a computing device (e.g., fixed computing device, mobile computing device) or a user of a computing device, unless otherwise stated.

It will be apparent that one or more embodiments, described herein, may be implemented in many different forms of software and/or hardware. Software code and/or specialized hardware used to implement embodiments described herein is not limiting of the invention. Thus, the operation and behavior of embodiments were described without reference to the specific software code and/or specialized hardware -- it being understood that one would be able to design software and/or hardware to implement the embodiments based on the description herein.

Further, certain features of the invention may be implemented using computer-executable instructions that may be executed by processing logic such as, for example, a processor. The computer-executable instructions may be stored on one or more non-transitory tangible computer-readable storage media. The media may be volatile or non-volatile and may include, for example, DRAM, SRAM, flash memories, removable disks, non-removable disks, and so on. The instructions when executed by a processor may cause the processor to perform one or more techniques described herein. For example, the instructions when executed by a processor may cause the processor to store information in a physical storage, receive a signal corresponding to one of a plurality of different protocols, identify the corresponding protocol from the plurality of different protocols based on a frequency associated with the received signal.

No element, act, or instruction used herein should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

It is intended that the invention not be limited to the particular embodiments disclosed above, but that the invention will include any and all particular embodiments and equivalents falling within the scope of the following appended claims.

What is claimed is:

1. A storage device comprising:
a tangible non-transitory physical storage for storing information;
an interface for receiving a plurality of different signals corresponding to a plurality of different protocols; and
circuitry for identifying a protocol from the plurality of different protocols from a signal received by the interface.

2. The storage device of claim 1, wherein the tangible non-transitory physical storage includes a volatile memory device or a non-volatile memory device.

3. The storage device of claim 1, wherein the tangible non-transitory physical storage includes a platter that magnetically stores the information.

4. The storage device of claim 1, further comprising:
drive logic for accessing information stored in the tangible non-transitory physical storage.

5. The storage device of claim 1, wherein the interface receives the signal serially.

6. The storage device of claim 1, wherein the interface receives the plurality of signals via a serial advanced technology attachment (SATA) cable.

7. The storage device of claim 1, wherein the identified protocol is one of the SATA protocol, the Internet Protocol (IP), the peripheral component interconnect express (PCIe) protocol, or the serial attached small computer system interface (SAS) protocol.

8. The storage device of claim 1, wherein the protocol is identified based on an attribute associated with the signal received by the interface.

9. The storage device of claim 8, wherein the attribute includes a frequency of the signal received by the interface.

10. The storage device of claim 1, wherein the protocol is identified based on information encoded in the signal received by the interface.

11. The storage device of claim 1, wherein the information encoded in the signal includes a header of a data packet.

12. An apparatus comprising:
means for storing information;
means for receiving a plurality of different signals corresponding to a plurality of different protocols; and
means for identifying a protocol from the plurality of different protocols from a signal received by the interface.

13. The apparatus of claim 12, wherein the tangible non-transitory physical storage includes a volatile memory device or a non-volatile memory device.

14. The apparatus of claim 12, wherein the tangible non-transitory physical storage includes a platter that magnetically stores the information.

15. The apparatus of claim 12, further comprising:
means for accessing information stored in the tangible non-transitory physical storage.

16. The apparatus of claim 12, wherein the interface receives the signal serially.

17. The apparatus claim 12, wherein the interface receives the plurality of signals via a serial advanced technology attachment (SATA) cable.

18. The apparatus of claim 12, wherein the identified protocol is one of the SATA protocol, the Internet Protocol (IP), the peripheral component interconnect express (PCIe) protocol, or the serial attached small computer system interface (SAS) protocol.

19. The apparatus of claim 12, wherein the protocol is identified based on an attribute associated with the signal received by the interface.

20. The apparatus of claim 19, wherein the attribute includes a frequency of the signal received by the interface.

21. The apparatus of claim 12, wherein the protocol is identified based on information encoded in the signal received by the interface.

22. A non-transitory computer-readable medium storing computer-executable instructions that when executed by a processor cause the processor to:
store information in a physical storage;
receive a signal corresponding to one of a plurality of different protocols; and
identify the corresponding protocol from the plurality of different protocols based on a frequency associated with the received signal.
